(19) United States
(12) Patent Application Publication
(10) Pub. No.: US 2023/0302653 A1
(43) Pub. Date: Sep. 28, 2023

(54) APPARATUS AND METHOD FOR TRANSPORTING A MACHINE OF A PRODUCTION LINE

(71) Applicant: OMRON Corporation, Kyoto-shi, Kyoto (JP)

(72) Inventors: Swaminathan VANGAL RAMAMURTHY, Singapore (SG); Raja NAGARAJAN, Singapore (SG); Rajaram JAYARAMAN, Singapore (SG)

(21) Appl. No.: 18/018,668

(22) PCT Filed: Jul. 27, 2021
(86) PCT No.: PCT/JP2021/027631

§ 371 Date: Jan. 30, 2023

(30) Foreign Application Priority Data
Aug. 1, 2020 (SG) 10202007338R

(51) Int. Cl. B25J 11/00; B25J 9/16; B62D 65/18

(52) U.S. Cl. CPC B25J 11/008; B25J 9/161; B25J 9/1694; B62D 65/18

(57) ABSTRACT

An apparatus and method for transporting a machine of a production line, wherein the apparatus comprises: a power supply; one or more parts for mobility; a driving mechanism for driving the one or more parts for mobility to move the apparatus; a docking mechanism for docking to a moveable cart comprising a machine of a production line; and a processor configured to execute instructions in a memory to operate the apparatus to: dock to the cart through the docking mechanism; transport the docked cart to a work cell in the production line; move the cart such that the cart docks with the work cell when the cart is transported to the work cell; and undock the cart when the cart is docked to the work cell and leave the machine to work at the work cell.

### TECHNICAL FIELD

The present invention relates to an apparatus and method for transporting a machine of a production line, a cart comprising the machine, and a work cell for docking to the cart.

### BACKGROUND ART

In a production line, autonomous mobile robots can be used to perform tasks like transportation of goods and inspection of environment and are capable of human interaction such as to take in instructions to move between instructed locations. The mobile robots may each be mounted with equipment for performing certain tasks. The equipment mounted on each mobile robot can be changeable but typically requires human intervention to do so.

### SUMMARY OF INVENTION

According to an example of the present disclosure, there are provided an apparatus and method for transporting a machine of a production line, as claimed in the independent claims. Some optional features are defined in the dependent claims.

### BRIEF DESCRIPTION OF DRAWINGS

FIG. 1 illustrates, according to one example of the present disclosure, a workflow of a mobile platform transporting a machine in a production line.

FIG. 2 shows a configuration of the mobile platform and a cart mounted with the machine corresponding to step 102 of FIG. 1.

FIG. 3 shows a configuration of the mobile platform and the cart with the mounted machine corresponding to step 104 of FIG. 1.

FIG. 4 shows a configuration of the mobile platform and the cart with the mounted machine corresponding to step 106 of FIG. 1.

FIG. 5 shows a configuration of the mobile platform and the cart with the mounted machine corresponding to step 108 of FIG. 1.

FIG. 6 shows a configuration of the mobile platform, the cart with the mounted machine, and a work cell in the production line corresponding to step 110 of FIG. 1.

FIG. 7 shows a configuration of the mobile platform, the cart with the mounted machine, and the work cell in the production line corresponding to step 112 of FIG. 1.

FIG. 8 shows a configuration of the mobile platform, the cart with the mounted machine, and the work cell in the production line corresponding to step 114 of FIG. 1.

FIG. 9 shows a configuration of the mobile platform, the cart with the mounted machine, and the work cell in the production line corresponding to step 116 of FIG. 1.

FIG. 10 illustrates, according to one example of the present disclosure, a workflow of the cart of FIGS. 2 to 9 docking to the work cell of FIGS. 6 to 9.

FIG. 11 illustrates, according to one example of the present disclosure, specific features in the cart of FIGS. 2 to 9.

FIG. 12 illustrates, according to one example of the present disclosure, specific features in the work cell of FIGS. 6 to 9.

FIG. 13 illustrates, according to one example of the present disclosure, specific features in the cart of FIGS. 2 to 9 and the work cell of FIGS. 6 to 9.

FIG. 14 is an enlarged view illustrating docking mechanisms of the cart of FIGS. 2 to 9 and the work cell of FIGS. 6 to 9.

### DESCRIPTION OF EMBODIMENTS

In a production line, apparatuses such as mobile platforms may each be mounted with machinery or equipment, so the mobile platform becomes a mobile station for performing tasks using the mounted machinery or equipment. Other equivalent terms used in the present disclosure to refer to such mounted machinery or equipment are “payload” or “machine”.

In an example of the present disclosure, there is a provided an apparatus for transporting a machine in a production line that solves a problem that human intervention is required to change a machine mounted on a mobile robot or platform. The apparatus of the present example is a mobile platform that has a power supply, one or more parts for mobility, such as wheel or track, and a driving mechanism such as a motor for driving the one or more parts for mobility to move the mobile platform. A mobile platform can have a top configured like a platform for receiving items. The apparatus of examples of the present disclosure is not limited to such configuration. In other examples, mobile robots with other configurations can also be applicable. The driving mechanism can be powered by the power supply. The mobile platform has a docking mechanism for docking to a moveable cart mounted with the machine. The mobile platform is configured to move the docked cart to a work cell in the production line.

The work cell refers to a station that is designated to perform a specific task in the production line. The work cell can be a mobile station with a portable power supply, or a stationary station. In the case that the work cell is a stationary station, the work cell can draw power from electricity mains supply. The work cell requires use of the machine transported by the mobile platform to perform the specific task.

The mobile platform is configured to undock the cart after the cart is docked to the work cell. In this manner, the work cell can use the machine mounted on the cart to perform the specific task. The mobile platform is not fixed to the machine and can move the machine around by moving the cart that is mounted to the machine. The mobile platform is free to perform other tasks such as to transport other machines around after it undocks from the cart. The mobile platform is not restricted to mounting to only one type of machine, and the machines to be mounted to the mobile platform are swappable.

The moveable cart comprises the machine, one or more parts for mobility such as wheels, a first docking mechanism for docking to the docking mechanism of the mobile platform, and a second docking mechanism for docking the cart to the work cell when the mobile platform transports the cart to the work cell.

Each mobile platform can have self-navigation and/or self-mapping systems on board, and a controller or processor for controlling its movements. Wireless communication devices are provided in the mobile platform to enable wireless communication via WIFI, telecommunication networks such as 3G, 4G, 5G, and the like. Instructions to control the tasks of the mobile platform can be communicated wirelessly. The controller or processor executes instructions in a memory to operate the mobile platform. The controller or processor can be connected to user input devices and/or a display for displaying a graphical user interface to take in user input. User input provided via the user input devices and/or graphical user interface can comprise instructions to control the tasks of the mobile platform and its movements. There can be provided a user control interface for such display and user input. Each mobile platform can also have traffic control systems to avoid collision and to optimize movements relative to other mobile platforms also operating at the production line.

Furthermore, the mobile platform can have one or more sensors. The controller or processor of the mobile platform can be configured to receive input from the one or more sensors and operate the mobile platform to:
align with the cart so as to dock with the cart; and
align with the work cell so as to enable the cart to dock to the work cell when the docked cart is transported to the work cell.

For example, each mobile platform can have one or more LiDAR sensor on board.

The one or more sensors can be part of an existing cell alignment positioning system (CAPS) developed by Omron Corporation. CAPS uses a main safety scanning laser (i.e., the LiDAR sensor) to detect a geometry in an environment and enables the mobile platform to drive to a specific location relative to that geometry during alignment conducted by the mobile platform. Specifically, CAPS can use point data information from a planar LiDAR sensor that is built into the mobile platform to align with reference targets based on triangulation and other geometrical feature analysis. CAPS is just one method to enable the mobile platform to conduct alignment. Other suitable methods can also be used.

In other examples, the one or more sensors can be or include cameras capturing images and alignment can be established based on image processing of captured images. The one or more sensors may also include laser, infrared and/or ultrasonic sensors. There may also be visual or smart labels or markers provided on the mobile platform, cart, machine and/or work cell to facilitate alignment and docking.

In the present example, the machine or payload mounted on the cart can be divided into 2 types: powered and non-powered.

A powered payload that has its own power supply and/or has the ability to draw power from the mobile platform's power supply to drive devices in the payload. Examples of such devices are robot arms, monitor screens, user control interface, and conveyor belts. For powered payload, there is an advantage that there is no discontinuity in the power supply to the devices in the payload. Hence, there is no delay in the use of the devices because they are always powered. Specifically, there is no time delay on powering up sequence.

A non-powered payload is for example, a cart mounted with a payload that does not have a power supply and no connections for drawing power from the mobile platform's power supply. For such non-powered payload, it has to be connected to a power supply of a work cell in order to operate any electrical devices. The cart can have one or more parts for mobility, for example, passive castor wheels, to enable the mobile platform to move the cart around. The cart can have a docking mechanism for a mobile platform to dock on before the mobile platform moves the cart to a predetermined location. In the case of non-powered payload, there may be a delay in the use of the devices because a powering up sequence has to commence after connecting to the power supply of the work cell.

In the case of the powered payload with its own power supply, the powered payload can be configured to rely on its own power supply to operate independently or connect to the power supply of the work cell and rely on the power supply of the work cell to operate when a cart mounted with the payload is transported to the work cell by the mobile platform.

In the case of the powered payload that is able to draw power from the power supply of the mobile platform, such powered payload can be configured to rely on the power supply of the mobile platform to operate independently or connect to the power supply of the work cell and rely on the power supply of the work cell to operate when a cart mounted with the payload is transported to the work cell by the mobile platform.

Optionally, the mobile platform can be configured such that its power supply is charged by the power supply of the powered payload. In this case, the mobile platform will have no idle time. The powered payload can also be configured such that its power supply is charged by the power supply of the mobile platform. In this case, it is ensured that the devices of the powered payload are always operational. Furthermore, the powered payload can be configured such that its power supply is charged by the power supply of the work cell when the cart mounted with the powered payload is transported to the work cell by the mobile platform. In this case, it is ensured that the devices of the powered payload are always operational even after the powered payload is detached from the power supply of the work cell.

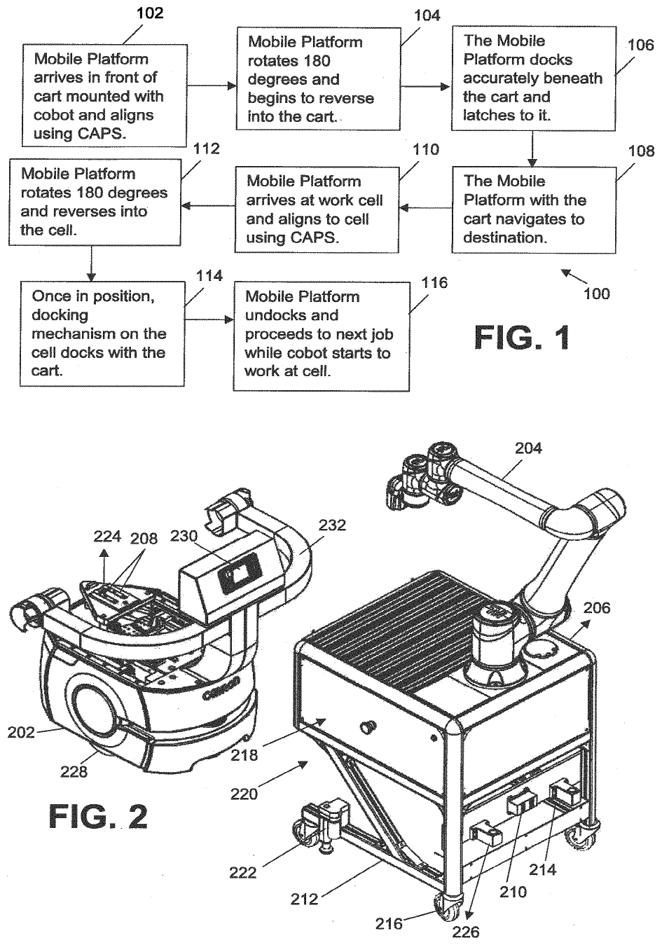

FIG. 1 shows a flowchart 100 setting out how a mobile platform can be used to transport a machine or payload that is mounted to a cart according to an example of the present disclosure. FIGS. 2 to 9 illustrates the steps carried out in the flowchart of FIG. 1.

With reference to FIGS. 1 to 9, the machine or payload is a cobot or collaborative robot 204 to be used in a production line. The mobile platform 202 is instructed to move to a location of the cart 206, dock with the cart 206, and transport the cobot 204 mounted on the cart 206 to a work cell 602 that has to collaborate with the cobot 204 to complete one or more tasks. The mobile platform 202 has wheels 228.

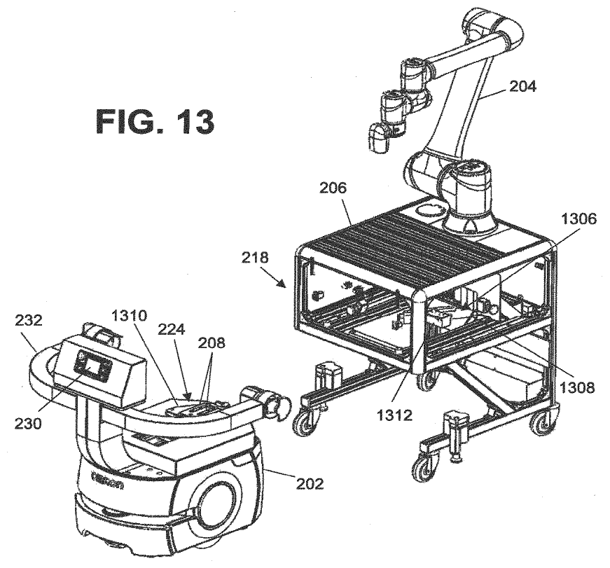

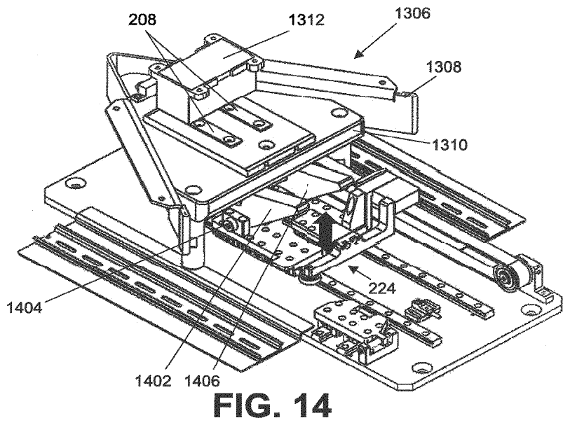

The mobile platform 202 has a docking mechanism 224 for docking to a first docking mechanism (not visible in FIGS. 2 to 9; 1306 in FIG. 13) of the cart 206. The docking mechanism 224 has an electrical connector 208 comprising positive and negative terminals to connect with the cobot 204 to power up the cobot 204 once the mobile platform 202 docks with the cart 206. Once docked, the electrical connector 208 of the mobile platform 202 is connected to a first electrical connector (not visible in FIGS. 2 to 9) in the cart 206. The first electrical connector in the cart 206 has positive and negative terminals for connecting to the corresponding positive and negative terminals of the electrical connector 208. The first electrical connector in the cart 206 is wired to the cobot 204 and power from the electrical connector 208 of the mobile platform 202 can be transmitted to the cobot 204. The cobot 204 is powered up when the cart 206 is transported by the mobile platform 202 to the work cell 602. When the cart 206 reaches the work cell 602, the mobile platform 202 aligns the cart 206 to enable the cart 206 to dock with the work cell 602. Furthermore, the mobile platform 202 is mounted with a user control interface 230 with a display that may be a touchscreen for taking in user input, and user handle 232 to enable the mobile platform 202 to be manually pushed if required. In one example, the user control interface 230 can be configured to control the cobot 204 on the cart 206 after the mobile platform 202 is docked to the cart 206.

The cart 206 has a second docking mechanism 226 for docking to a docking mechanism 226 of the work cell 602. The second docking mechanism 226 has a second electrical connector 210 with positive and negative terminals and the docking mechanism 226 of the work cell 602 has an electrical connector 604 with corresponding positive and negative terminals. The second electrical connector 210 is arranged to connect to the electrical connector 604 of the work cell 602 when the cart 206 and the work cell 602 are docked. The electrical connector 604 of the work cell 602 is connected to a power supply of the work cell 602, which can be electricity mains supply. Once the second electrical connector 210 of the cart 206 is connected to the power supply of the work cell 602, power to the cobot 204 is switched to be drawn from the power supply of the work cell 602 instead of the power supply of the mobile platform 202. After this switching of power supply is completed, the mobile platform 202 can detach from the cart 206 and move on to its next job. The cobot 204 will perform its task at the work cell 602. In this manner, there is no discontinuity in the power supply to the cobot 204 and no time is wasted on powering up sequence of the cobot 204. The mobile platform 202 is also not fixed to the cobot 204 and can move on to perform other jobs. As such, the utilization rate of the mobile platform 202 is increased.

The electrical connection of the electrical connector 208 and the first electrical connector in the cart 206 can include power line for power transfer and/or data line for data communication between a controller or processor of the mobile platform 202 and a controller or processor of the cart 206. Similarly, the electrical connection of the second electrical connector 210 and the electrical connector 604 of the work cell 602 can include power line for power transfer and/or data line for data communication between a controller or processor of the cobot 204 and a controller or processor of the work cell 602.

With reference to FIG. 1 and FIG. 2, at a step 102 in FIG. 1, the mobile platform 202 arrives in front of the cart 206 mounted with the cobot 204 and aligns with the cart 206 using CAPS. In FIG. 2, a front side of the mobile platform 202 is facing a rear side of the cart 206. The electrical connector 208 of the mobile platform 202 is located at a rear side of the mobile platform 202. An objective of this alignment is to align the first docking mechanism (not visible in FIG. 2; 1306 in FIG. 13) of the cart 206 with the docking mechanism 224 of the mobile platform 202 and enable the first electrical connector (not visible in FIG. 2) of the cart 206 to connect to the electrical connector 208 of the mobile platform 202.

FIG. 2 also shows a front side of the cart 206 showing an electrical connector of the cart 206 for connecting to the electrical connector 604 in FIG. 6 of the work cell 602 in FIG. 6 when the cart 206 is docked to the work cell 602 in FIG. 6.

The cart 206 has an elevated upper body 218 forming a planar stage for mounting the cobot 204 and a lower body 220 comprising support frames 212 and 214 arranged in a manner to provide space for the mobile platform 202 to move to a position between the support frames 212 and 214 and below the upper body 218. In the present example, the upper body 218 is cuboid in shape. Connectors, power supply, controller, or processor for the cobot 204, and/or wirings can be mounted within a hollow space of the upper body 218. The support frames 212 and 214 are disposed on left and right sides of the cart 206 and are extended from the upper body 218 towards the ground. The support frames 212 and 214 are spaced apart to provide a space between the left and right sides of the cart 206 for the mobile platform 202 to move below the upper body 218 and allow the mobile platform 202 to dock with a bottom side of the upper body 218 of the cart 206. Once docked, an electrical connector of the mobile platform 202 will engage the electrical connector (not visible in FIGS. 2 to 9) in the cart 206. The cart 206 has four wheels 216 spaced apart at four corners relative to a bottom side of the cuboid upper body 218 that is facing the ground. The four wheels 216 are mounted at bottoms of the support frames 212 and 214 to form feet of the cart 206 at the four corners to enable the cart 206 to be wheeled around. The cart 206 comprises a braking mechanism 222 for applying a brake to prevent movement of the wheels 216 of the cart as required, such as after the cart 206 is docked to the work cell 602 in FIG. 6.

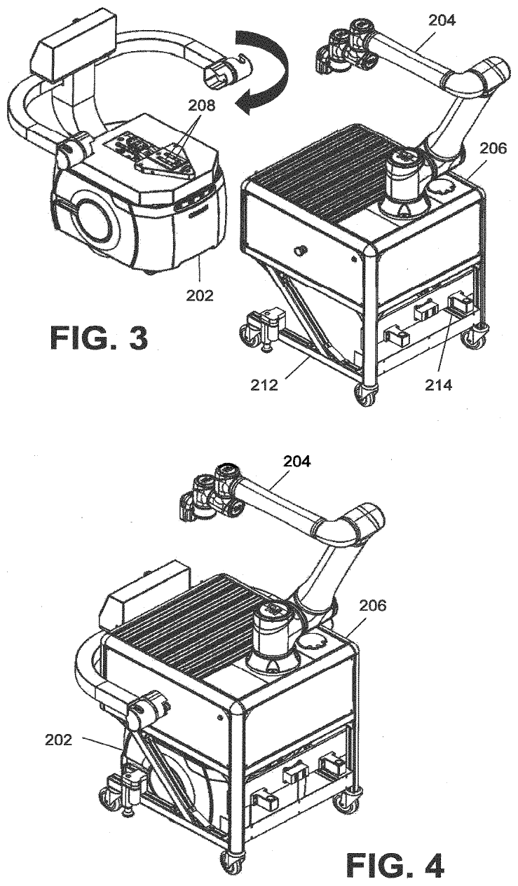

With reference to FIG. 1 and FIG. 3, at a step 104 in FIG. 1, after the alignment at step 102 is completed, the mobile platform 202 rotates 180 degrees (as illustrated by an arrow in FIG. 3) so that the rear side of the mobile platform 202 with the docking mechanism 224 faces the side of the cart 206 for the mobile platform 202 to move in to dock with the cart 206. The angle by which the mobile platform 202 has to rotate depends on how the docking mechanism 224 is mounted on the mobile platform 202. When the rear side of the mobile platform 202 faces the side of the cart 206 for the mobile platform 202 to move in to dock with the cart 206, the mobile platform 202 begins to reverse into the cart 206 between the spaced apart support frames 212 and 214 so as to dock with the cart 206.

With reference to FIG. 1 and FIG. 4, at a step 106 in FIG. 1, after the mobile platform 202 reverses into the cart 206, the mobile platform 202 docks accurately beneath the cart 206, specifically, the mobile platform 202 docks to the bottom side of the upper body 218 of the cart 206. When docked, the docking mechanism 224 of the mobile platform 202 is docked to the first docking mechanism (1306 in FIG. 13) of the cart 206 located at the bottom side of the upper body 218 of the cart 206. Furthermore, when docked, the first electrical connector (not visible in FIG. 4) of the cart 206 is connected to the electrical connector 208 of the mobile platform 202. Thereafter, the mobile platform 202 supplies power to the cobot 204. The cobot 204 begins powering up sequence and remains powered up until the cart 206 docks with the work cell 602 in FIG. 6.

In another example in which the cart 206 or cobot 204 has a power supply, the power supply of the mobile platform 202 can be charged by the power supply of the cart 206 or cobot 204 when the mobile platform 202 is docked with the cart 206.

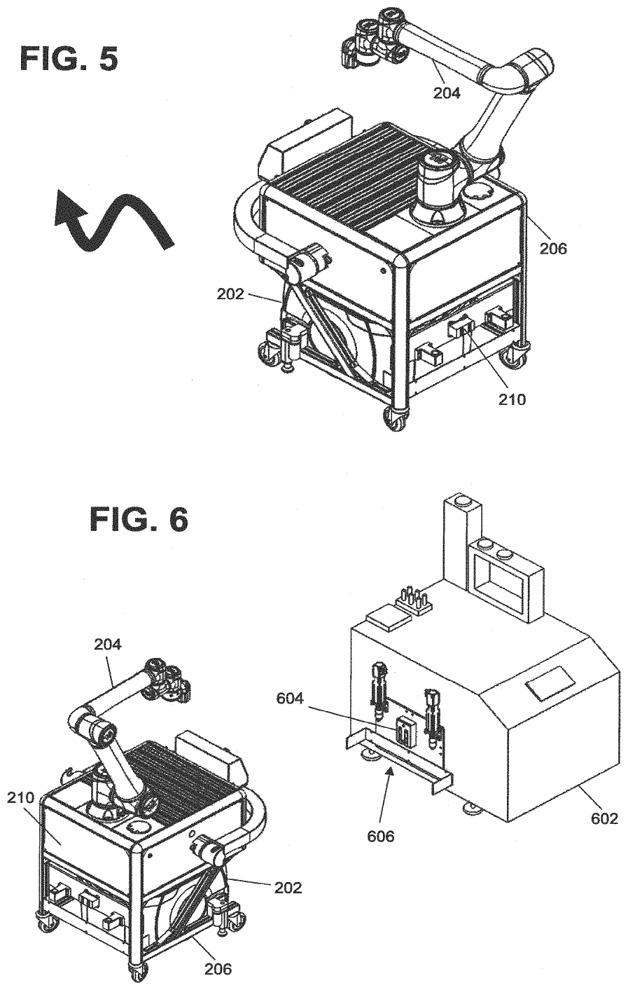

With reference to FIG. 1 and FIG. 5, at a step 108 in FIG. 1, the mobile platform 202 navigates and moves the docked cart 206 to a predetermined destination, which in this example is the work cell 602 in FIG. 6. The movement of the mobile platform 202 is illustrated by an arrow in FIG. 5.

With reference to FIG. 1 and FIG. 6, at a step 110 in FIG. 1, the mobile platform 202 transporting the docked cart 206 arrives at the work cell 602 and aligns to the work cell 602 using CAPS. The objective of this alignment is to align the second docking mechanism 226 of the cart 206 with the docking mechanism 606 of the work cell 602 and enable the second electrical connector 210 of the cart 206 to connect to the electrical connector 604 of the work cell 602.

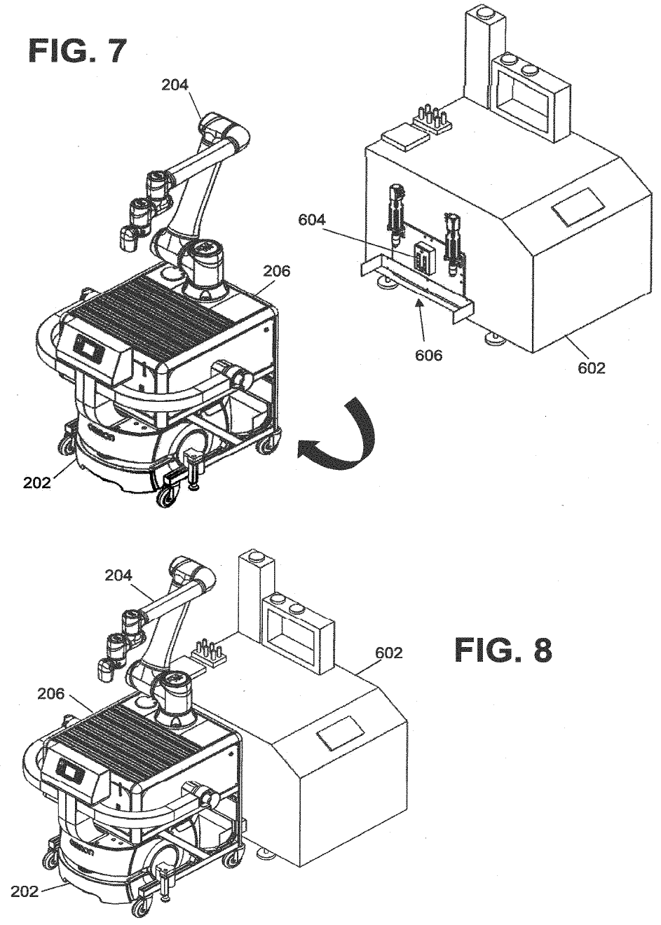

With reference to FIG. 1 and FIG. 7, at a step 112 in FIG. 1, once the mobile platform 202 and the work cell 602 are aligned, the second docking mechanism 226 of the cart 206 is aligned to dock with the docking mechanism 606 of the work cell 602. The mobile platform 202 then rotates 180 degrees (as illustrated by an arrow in FIG. 7) and reverses towards the work cell 602 for the docking of the cart 206 and the work cell 602 to take place.

With reference to FIG. 1 and FIG. 8, at a step 114 in FIG. 1, after the mobile platform 202 is reversed to the work cell 602, the docking mechanism 606 of the work cell 602 docks with the second docking mechanism 226 of the cart 206. Furthermore, the second electrical connector 210 of the cart 206 connects with the electrical connector 604 of the work cell 602. Thereafter, the power supply of the mobile platform 202 stops supplying power to the cobot 204 and the power supply of the work cell 602 takes over to supply power to the cobot 204. During the switching of power supply, no discontinuity in the supply of power to the cobot 204 is ensured.

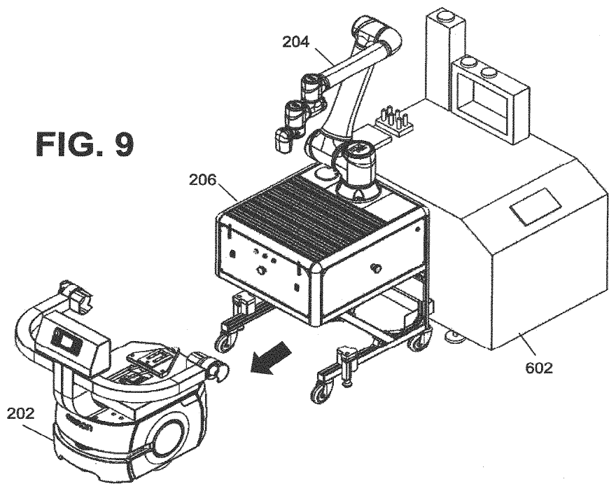

With reference to FIG. 1 and FIG. 9, at a step 116 in FIG. 1, the mobile platform 202 undocks from the cart 206, leaves (indicated by arrow in FIG. 9) and proceeds to a next job while the cobot 204 starts to work at the work cell 602.

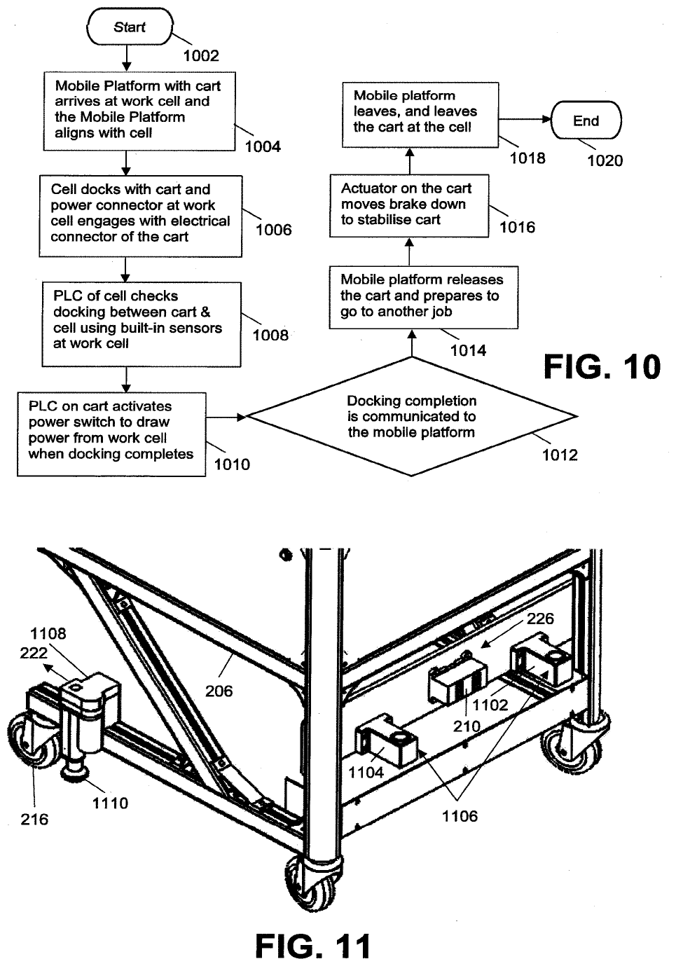

FIGS. 10 to 12 illustrate in more detail an example of the docking process between the cart 206 of FIGS. 2 to 9 and the work cell 602 of FIGS. 6 to 9 and illustrate an example of how the mobile platform 202 is notified of completion of docking between the cart 206 and the work cell 602 and gets ready to leave the cart 206.

With reference to FIGS. 6 to 9 and FIG. 10, the docking process between the cart 206 and the work cell 602 starts at a step 1002.

At a step 1004 of FIG. 10, illustrated by FIGS. 6 and 7, the mobile platform 202 with the cart 206 arrives at the work cell 602 and the mobile platform 202 aligns with the work cell 602 using CAPS. When the mobile platform 202 is aligned with the work cell 602, the cart 206 is also aligned for docking with the work cell 602. Once aligned, the mobile platform 202 moves and orientates the cart 206 so that docking between the cart 206 and the work cell 602 can take place.

At a step 1006 of FIG. 10, with reference to FIG. 7, the cart 206 docks with the work cell 602 and the electrical connector 604 at the work cell 602 engages with the second electrical connector 210 of the cart 206.

At a step 1008 of FIG. 10, a Programmable Logic Controller (PLC) of the work cell 602 checks the docking between the cart 206 and the work cell 602 using one or more sensors provided at the work cell 602. The one or more sensors provide input to the PLC of the work cell 602 to determine whether the docking is completed. In the present example, docking is completed when electrical engagement is complete i.e. the electrical connector 604 at the work cell 602 is connected to the second electrical connector 210 of the cart 206, and when physical engagement is also complete i.e. locking mechanisms of the cart 206 and the work cell 602 are engaged. Details of such locking mechanisms will be discussed later.

With regard to electrical engagement, the electrical connector 604 at the work cell 602 may be connected to the second electrical connector 210 of the cart 206 via magnetic engagement. One or more magnetic sensor can be provided to detect changes in magnetism due to the magnetic engagement. This magnetic sensor can provide input to the PLC of the work cell 602 to determine whether the docking is completed.

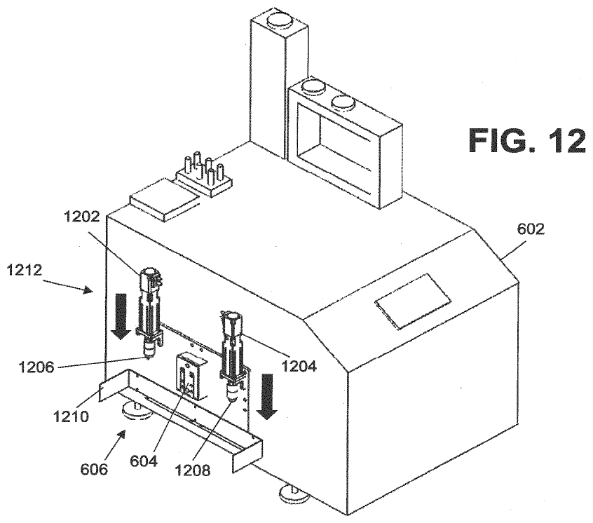

With reference to FIG. 11, the front side of the cart 206 with the second docking mechanism 226 and the second electrical connector 210 is shown. The second docking mechanism 226 comprises the second electrical connector 210 and a cart locking mechanism 1106 with two cart securing members 1102 and 1104 for receiving two respective cell securing members 1202 and 1204 in FIG. 12 of a cell locking mechanism 1212 in FIG. 12 of the work cell 602. In the present example, each of the cart securing members 1102 and 1104 has a female portion (e.g., hole) for receiving a corresponding male portion (e.g. extendable rod or shaft) of each of the respective cell securing members 1202 and 1204. In another example, one or both of the cart securing members 1102 and 1104 can have the male portion and one or both of the respective cell securing members 1202 and 1204 can have the corresponding female portion.

FIG. 12 shows the cell docking mechanism 606 of the work cell 602. The cell docking mechanism 606 comprises the cell locking mechanism 1212. The cell locking mechanism 1212 comprises the cell securing mechanisms 1202 and 1204. The cell securing mechanisms 1202 and 1204 can be actuated by respective electrically activated locking actuators 1206 and 1208 to move downwards (See arrows in FIG. 12) to cause the cell securing mechanisms 1202 and 1204 to engage the female portions of the respective cart securing members 1102 and 1104. Examples of the cell securing mechanisms 1202 and 1204 can include voice coil actuator, solenoid lock, and the like.

One or more sensors can be provided at the work cell 602 to detect whether the cell securing mechanisms 1202 and 1204 have engaged the cart securing members 1102 and 1104. Once such physical engagement is confirmed, the one or more sensor provide input to the PLC of the work cell 602 to deter mine that the docking is completed. An example of such one or more sensors could be a magnetic sensor to sense changes in magnetism if the electrically activated locking actuators 1206 and 1208 are actuated using magnetic effect to cause the cell securing mechanisms 1202 and 1204 to engage the female portions of the respective cart securing members 1102 and 1104.

FIG. 12 shows a plate 1210 with two opposite folded portions extending from the work cell 602. This plate 1210 is to be used during CAPS alignment between the mobile platform 202 and the work cell 602. Laser from a LiDAR sensor on board the mobile platform 202 is directed to this plate 1210 and the reflected laser from the plate 1210 are collected by the mobile platform 202 during alignment process. A similar plate as the plate 1210 can be mounted on the cart 206 to facilitate the alignment between the mobile platform 202 and the cart 206.

Returning to FIG. 11, FIG. 11 also shows the braking mechanism 222 of the cart 206. The braking mechanism 222 comprises an electrically activated actuator 1108 configured to move a braking friction pad or foot 1110 to contact the ground as required. The electrical signal to the actuator 1108 to activate the braking friction pad or foot 1110 can be sent from the PLC of the cart 206 as required. Once activated, the braking friction pad or foot 1110 prevents movement of the wheels 216 of the cart 206. In examples of the present disclosure, one or more of such braking mechanism 222 can be provided.

At a step 1010 of FIG. 10, the PLC of the work cell 602 notifies the PLC of the cart 206 to activate a power switch to draw power from the power supply of the work cell 602 instead of from the power supply of the mobile platform 202. This is done when the PLC of the work cell 602 determines that the electrical engagement between the cart 206 and the work cell 602 is completed. Such notification can be done via a data line in the electrical engagement between the cart 206 and the work cell 602 and/or via wireless data communication from the PLC of the work cell 602 to the PLC of the cart 206.

At a step 1012 of FIG. 10, the PLC of the work cell 602 notifies the mobile platform 202 that docking between the work cell 602 and the cart 206 is completed. The PLC of the work cell 602 can provide this feedback on docking completion to the PLC of the cart 206 and the PLC of the cart 206 in turn passes the feedback to the mobile platform 202, which is electrically connected to the PLC of the cart 206. Other methods of providing this feedback can be via wireless data communication from the PLC of the work cell 602 to the mobile platform 202. In the present example, docking is deemed to be completed when the PLC of the work cell 602 determines that both the electrical engagement and the physical engagement between the cart 206 and the work cell 602 are completed.

At a step 1014 of FIG. 10, when the mobile platform 202 is notified that the docking is completed, the mobile platform 202 releases its docking mechanism 224 from the first docking mechanism (1306 in FIG. 13) of the cart 206 and prepares to move on to another job.

At a step 1016 of FIG. 10, any time after the PLC of the work cell 602 determines that the docking between the cart 206 and the work cell 602 is completed and notifies the PLC of the cart 206 of the docking completion, the PLC of the cart 206 sends a signal to activate the actuator 1108 of the braking mechanism 222 of the cart 206 to move the braking friction pad or foot 1110 to contact the ground to stabilize the cart 206.

At a step 1018 of FIG. 10, once the docking mechanism 224 of the mobile platform 202 is released from the first docking mechanism (1306 in FIG. 13) of the cart 206, the mobile platform 202 leaves the cart 206, and the cart 206 is left to work at the work cell 602.

The docking process between the cart 206 and the work cell 602 ends at a step 1020.

FIGS. 13 and 14 illustrate in more detail an example of the docking process between the same mobile platform 202 and the same cart 206 of FIGS. 2 to 9.

With reference to FIG. 13, the mobile platform 202 comprises the docking mechanism 224 described earlier and the docking mechanism 224 comprises the electrical connector 208 described earlier. The elevated upper body 218 of the cart 206 is deliberately drawn with see-through sides to reveal components disposed within the upper body 218. At the bottom side of the upper body 218, there is provided the first docking mechanism 1306 of the cart 206. The first docking mechanism 1306 of the cart 206 comprises the first electrical connector 1312 of the cart 206 for connecting to the electrical connector 208 of the mobile platform 202 and also comprises one or more receiving members 1308.

The docking mechanism 224 comprises a latching member 1310 with a shape corresponding to the one or more receiving members 1308 to facilitate the one or more receiving members 1308 to receive the latching member during the docking of the mobile platform 202 to the cart 206. In the present example, the shape of the latching member 1310 is substantially triangular and an apex of the triangular shape faces a center of the cart 206 when the mobile platform 202 is aligned to dock with the cart 206. The one or more receiving members 1308 are in this example, two plates arranged in an open configuration, for receiving the latching member 1310 with the apex facing the center of the cart 206. Furthermore, in this example, the electrical connector 208 is disposed within the latching member 1310.

FIG. 14 is an enlarged view of the docking mechanism 224 of the mobile platform 202 when it is docked to the first docking mechanism 1306 of the cart 206 in FIG. 13. Specifically, in FIG. 14, the triangular shaped latching member 1310 is fully received by the two plates of the one or more receiving members 1308. The electrical connector 208 of the mobile platform 202 is connected to the first electrical connector 1312 of the cart 206. In the present example, the docking mechanism 224 and the first docking mechanism 1306 are secured together to each other via strong magnetic connection. One or more magnetic devices (not shown in FIGS. 13 and 14) are provided in the cart 206 and/or the mobile platform 202 to achieve this. For example, the first electrical connector 1312 can comprise an extendable charge pad extendable via magnetic effect for connecting to the electrical connector 208 configured as a fixed base pad. In the example of FIG. 14, no physical engagement similar to the cell locking mechanism 1212 in FIG. 12 are present to further secure the docking of the mobile platform 202 to the cart 206. However, in other examples, similar locking mechanisms can be provided to further secure the docking of the mobile platform 202 to the cart 206.

FIG. 14 also shows two moveable connector pads 1402 and 1406, wherein one of them is a positive terminal and the other is a negative terminal. These connector pads 1402 and 1406 are located below the electrical connector 208. In the present example, the two moveable connector pads 1402 and 1406 are hinged at respective pivots 1404 and are each movable about these pivots 1404. The two moveable connector pads 1402 and 1406 are pivotable in directions indicated by the arrow in FIG. 14 to engage the electrical connector 208 to electrically connect the mobile platform 202 and the cart 206 when the mobile platform 202 is docking to the cart 206, or to disengage the electrical connector 208 when the mobile platform 202 is undocking from cart 206.

In relation to power supply of the examples of the present disclosure, the following are some possible scenarios.
a) The mobile platform 202 has a power supply, the cart 206 and machine 204 (e.g. cobot) have no power supply, and power is provided to the machine 204 by the mobile platform 202 when the mobile platform 202 docks with the cart 206. The machine 204 can operate as long as the mobile platform 202 is docked.
b) The mobile platform 202 has a power supply, the cart 206 and machine 204 (e.g., cobot) have no power supply, and the work cell 602 has power supply. When the mobile platform 202 transports the cart 206 to the work cell 602, power supply to the machine 204 is switched from the power supply of the mobile platform 202 to the power supply of the work cell 602. After the switch, the mobile platform 202 is free to move to another job and the machine 204 stays at the work cell 602 to work.
c) The mobile platform 202 has a power supply, either the cart 206 or machine 204 (e.g. cobot) or both has a power supply to operate the machine, and the work cell 602 has a power supply. When the mobile platform 202 transports the cart 206 to the work cell 602, optionally, power supply to the machine 204 can be switched from the power supply of the cart 206 or machine 204 to the power supply of the work cell 602. Optionally, the power supply of the cart 206 or machine 204 can be charged by the power supply of the work cell 602, or the power supply of the work cell 602 is charged by the power supply of the cart 206 or machine 204. Optionally, the power supply of the mobile platform 202 can charge the power supply of the cart 206 or machine 204 when the mobile platform 202 is docked to the cart 206.
d) The mobile platform 202 has a power supply, either the cart 206 or machine 204 (e.g., cobot) or both has a power supply to operate the machine, and the work cell 602 has a power supply. The power supply of the mobile platform 202 can be charged by the power supply of the cart 206 or machine 204 when the mobile platform 202 is docked to the cart 206. The cart 206 becomes a charging station for the mobile platform 202 in this scenario.

An example of the mobile platform 202 in FIGS. 2 to 9, the cart 206 in FIGS. 2 to 9, the machine mounted on the cart 206 (e.g., cobot 204 in FIGS. 2 to 9), and the work cell 602 in FIGS. 6 to 9 may have the following components in electronic communication via a bus:
1. a display (e.g., 230 in FIG. 2);
2. non-volatile memory and/or non-transitory computer readable medium;
3. random access memory (“RAM”);
4. N number of processing components (i.e., “one or more controllers”, “one or more processors” or “one or more central processing units”);
5. a transceiver component that includes N number of transceivers for Internet/Intranet use, and/or Wireless Network communications;
6. user controls i.e., user input devices;
7. optionally, image capturing components;
8. optionally, audio signal capturing components (e.g., microphone);
9. optionally, audio speakers;
10. where required, one or more sensors and/or components for alignment purposes, docking detection purposes, and/or navigation/area mapping purposes; and
11. Input/Output interfaces for connecting to the user input devices (such as mouse, joystick, keyboard, sensors for detecting user gestures, and the like), the audio speakers, display, image capturing components and/or audio signal capturing components.

The display generally operates to provide a presentation of graphical content (e.g., graphical user interface) to a user, and may be realized by any of a variety of displays (e.g., CRT, LCD, HDMI, micro-projector and OLED displays). The display may be a touchscreen.

In general, the non-volatile memory functions to store (e.g., persistently store) data and executable code including code that is associated with the functional components of the mobile platform. In some cases, for example, the non-volatile memory includes bootloader code, modem software, operating system code, file system code, as well as other codes well known to those of ordinary skill in the art that are not depicted for simplicity. With regard to the mobile platform 202, there may be self-navigation/mapping code, and code to facilitate the docking/undocking processes of the mobile platform 202, alignment process of the mobile platform 202 with the cart 206 in FIGS. 2 to 9, and/or alignment process of the mobile platform 202 with the work cell 602 in FIGS. 6 to 9. With regard to the cart 206 or the machine mounted to the cart 206, there may be code for activating the braking mechanism 222 in FIGS. 2 and 11, code to transfer power supply to the machine (e.g. 204 in FIGS. 2 to 9) from the power supply of the mobile platform 202 to the power supply of the work cell 602, code to facilitate the docking/undocking processes of the cart 206, alignment process of the mobile platform 202 with the cart 206, alignment process of the cart 206 with the work cell 602. With regard to the work cell 602, there may be code to facilitate the docking/undocking processes of the cart 206 and work cell 602, and/or alignment process of the mobile platform 202 with the work cell 602.

In many implementations, the non-volatile memory is realized by flash memory (e.g., NAND or NOR memory), but it is certainly contemplated that other memory types may be utilized as well. Although it may be possible to execute the code from the non-volatile memory, the executable code in the non-volatile memory is typically loaded into RAM and executed by one or more of the N processing components.

One or more computer programs may be stored on any machine or computer readable medium that may be non-transitory in nature. The computer readable medium may include storage devices such as magnetic or optical disks, memory chips, or other storage devices suitable foo interfacing with the mobile platform. The machine or computer readable medium may also include a hard-wired medium such as exemplified in the Internet system, or wireless medium such as exemplified in the Wireless LAN (WLAN) system.

The N processing components (or “one or more processors”) in connection with RAM generally operate to execute the instructions stored in non-volatile memory to effectuate the functional components. As one skilled in the art (including ordinarily skilled) will appreciate, the N processing components may include a video processor, modem processor, DSP, graphics processing unit (GPU), and other processing components.

The transceiver component may include N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a WIFI network, a CDMA network, a GPRS network, a UMTS networks), and other types of communication networks. In some implementations, the communication of the transceiver component with communication networks enables a location of connected devices to be determined.

Examples of the present disclosure may have the following features.

An apparatus (e.g., 202 in FIGS. 2 to 9) for transporting a machine (e.g., 204 in FIGS. 2 to 9) of a production line, wherein the apparatus comprises:
a power supply;
one or more parts for mobility (e.g., 228 in FIG. 2);
a driving mechanism for driving the one or more parts for mobility to move the apparatus;
a docking mechanism (e.g., 224 in FIG. 2) for docking to a moveable cart (e.g., 206 in FIGS. 2 to 9) comprising a machine (e.g., 204 in FIGS. 2 to 9) of a production line; and
a processor configured to execute instructions in a memory to operate the apparatus to:
dock to the cart using the docking mechanism;
transport the docked cart to a work cell (e.g., 602 in FIGS. 6 to 9) in the production line;
move the cart to dock the cart to the work cell when the cart is transported to the work cell;
undock the cart when the cart is docked to the work cell and leave the machine to work at the work cell.

The apparatus may comprise:
one or more sensors; and
the apparatus is operable to:
receive input from the one or more sensors to align with the cart so as to dock with the cart and align with the work cell so as to enable the cart to dock to the work cell when the docked cart is transported to the work cell.

The docking mechanism may comprise:
a latching member (e.g., 1310 in FIGS. 13 & 14) with a shape corresponding to one or more receiving members (e.g., 1308 in FIGS. 13 & 14) residing in the cart to facilitate the one or more receiving members to receive the latching member during the docking of the apparatus to the cart.

The apparatus may comprise:
a first electrical connector (e.g., 208 in FIGS. 2, 13 and 14) configured to connect to the cart or machine to provide power to the machine when the apparatus is docked to the cart.

The apparatus may comprise:
a second electrical connector configured to connect to a power supply of the cart or machine to charge the power supply of the apparatus.

It is possible that the apparatus only has either the first electrical connector or the second electrical connector or have both. If only the second electrical connector is present, it can have the same configuration and position as the example of the first electrical connector 208 in FIGS. 2, 13 and 14.

The first electrical connector and/or the second electrical connector may be disposed in the latching member.

A cart to be transported by the apparatus, wherein the cart may comprise:
the machine of the production line;
one or more parts for mobility (e.g., 216 in FIGS. 2 & 11);
a first docking mechanism (e.g., 1306 in FIGS. 13 & 14) for docking to the docking mechanism of the apparatus; and
a second docking mechanism (e.g., 226 in FIGS. 2 & 11) for docking the cart to the work cell when the apparatus transports the cart to the work cell.

The cart or the machine may comprise:
a power supply configured to power the machine and to charge the power supply of the apparatus.

The cart or the machine may comprise:
a first electrical connector (e.g., 1312 in FIGS. 13 & 14) configured to connect to the power supply of the apparatus when the cart is docked to the apparatus to draw power from the power supply of the apparatus to power the machine.

The cart or the machine may comprise:
a second electrical connector (e.g., 210 in FIGS. 2 & 11) configured to connect to a power supply of the work cell when the cart is docked to the work cell to draw power from the power supply of the work cell to power the machine.

The first docking mechanism of the cart may comprise:
the one or more receiving members.

The cart may comprise:
a braking mechanism (e.g., 222 in FIGS. 2 & 11) for applying a brake to prevent movement of the one or more parts for mobility of the cart,
wherein the braking mechanism is configured to electrically activate automatically to apply the brake after the cart is docked to the work cell.

The second docking mechanism of the cart may comprise:
a cart locking mechanism (e.g., 1106 in FIG. 11) configured to engage a cell locking mechanism (e.g., 1212 in FIG. 12) of the work cell to prevent the movement of the cart relative to the work cell.

A work cell of a production line, wherein the work cell may comprise:
a cell docking mechanism (e.g., 1212 in FIG. 12) for docking to the second docking mechanism of the cart when the apparatus transports the cart to the work cell;
one or more sensors to provide input to determine whether docking between the cart and the work cell is complete; and
a processor configured to execute instructions in a memory to operate the work cell to:
provide feedback to the apparatus that docking between the cart and the work cell is completed.

The cell docking mechanism may comprise:
a cell locking mechanism (e.g., 1212 in FIG. 12) to engage a cart locking mechanism (e.g., 1106 in FIG. 11) of the cart, and the cell locking mechanism is configured to be electrically activated to engage to the cart locking mechanism when the cart is docking to the work cell.

A method for transporting a machine (e.g., 204 in FIGS. 2 to 9) of a production line, wherein the method comprises:
docking an apparatus (e.g., 202 in FIGS. 2 to 9) to a cart (e.g., 206 in FIGS. 2 to 9) comprising a machine (e.g., 204 in FIGS. 2 to 9) of a production line;
transporting the docked cart to a work cell (e.g., 602 in FIGS. 6 to 9) in the production line using the apparatus;
moving the cart to dock the cart to the work cell when the cart is transported to the work cell by the apparatus; and
undocking the cart from the apparatus when the cart is docked to the work cell and leave the machine to work at the work cell.

The method may comprise:
providing power supply to the machine such that there is no discontinuity in power supply to the machine before and after docking of the cart to the work cell.

In the specification and claims, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on.

While the invention has been described in the present disclosure in connection with a number of examples and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. An apparatus for transporting a machine of a production line, wherein the apparatus comprises:
a power supply;
one or more parts for mobility;
a driving mechanism for driving the one or more parts for mobility to move the apparatus;
a docking mechanism for docking to a moveable cart comprising a machine of a production line; and
a processor configured to execute instructions in a memory to operate the apparatus to:
dock to the cart using the docking mechanism;
transport the docked cart to a work cell in the production line;
move the cart to dock the cart to the work cell when the cart is transported to the work cell;
undock the cart when the cart is docked to the work cell and leave the machine to work at the work cell.

2. The apparatus as claimed in claim 1, wherein the apparatus comprises:
one or more sensors; and
the apparatus is operable to:
receive input from the one or more sensors to align with the cart so as to dock with the cart and align with the work cell so as to enable the cart to dock to the work cell when the docked cart is transported to the work cell.

3. The apparatus as claimed in claim 1 or 2, wherein the docking mechanism comprises:
a latching member with a shape corresponding to one or more receiving members residing in the cart to facilitate the one or more receiving members to receive the latching member during the docking of the apparatus to the cart.

4. The apparatus as claimed in any one of claims 1 to 3, wherein the apparatus comprises:
a first electrical connector configured to connect to the cart or machine to provide power to the machine when the apparatus is docked to the cart.

5. The apparatus as claimed in any one of claims 1 to 4, wherein the apparatus comprises:
a second electrical connector configured to connect to a power supply of the cart or machine to charge the power supply of the apparatus.

6. The apparatus as claimed in claim 4 or 5, wherein the first electrical connector and/or the second electrical connector is or are disposed in the latching member.

7. A cart to be transported by the apparatus as claimed in any one of claims 1 to 6, wherein the cart comprises:
the machine of the production line;
one or more parts for mobility;
a first docking mechanism for docking to the docking mechanism of the apparatus; and
a second docking mechanism for docking the cart to the work cell when the apparatus transports the cart to the work cell.

8. The cart as claimed in claim 7, wherein the cart or the machine comprises:
a power supply configured to power the machine and to charge the power supply of the apparatus.

9. The cart as claimed in claim 7 or 8, wherein the cart or the machine comprises:
a first electrical connector configured to connect to the power supply of the apparatus when the cart is docked to the apparatus to draw power from the power supply of the apparatus to power the machine.

10. The cart as claimed in any one of claims 7 to 9, wherein the cart or the machine comprises:
a second electrical connector configured to connect to a power supply of the work cell when the cart is docked to the work cell to draw power from the power supply of the work cell to power the machine.

11. The cart as claimed in any one of claims 7 to 10, wherein the first docking mechanism comprises:
the one or more receiving members of claim 3.

12. The cart as claimed in any one of claims 7 to 11, wherein the cart comprises:
a braking mechanism for applying a brake to prevent movement of the one or more parts for mobility of the cart,
wherein the braking mechanism is configured to electrically activate automatically to apply the brake after the cart is docked to the work cell.

13. The cart as claimed in any one of claims 7 to 12, wherein the second docking mechanism comprises:
a cart locking mechanism configured to engage a cell locking mechanism of the work cell to prevent the movement of the cart relative to the work cell.

14. A work cell of a production line, wherein the work cell comprises:
a cell docking mechanism for docking to the second docking mechanism of the cart of any one of claims 7 to 13 when the apparatus of any one of claims 1 to 6 transports the cart to the work cell;
one or more sensors to provide input to determine whether docking between the cart and the work cell is complete; and
a processor configured to execute instructions in a memory to operate the work cell to:
provide feedback to the apparatus that docking between the cart and the work cell is completed.

15. The work cell as claimed in claim 14, wherein the cell docking mechanism comprises:
a cell locking mechanism to engage a cart locking mechanism of the cart, and the cell locking mechanism is configured to be electrically activated to engage to the cart locking mechanism when the cart is docking to the work cell.

16. A method for transporting a machine of a production line, wherein the method comprises:
docking an apparatus to a cart comprising a machine of a production line;
transporting the docked cart to a work cell in the production line using the apparatus;
moving the cart to dock the cart to the work cell when the cart is transported to the work cell by the apparatus; and
undocking the cart from the apparatus when the cart is docked to the work cell and leave the machine to work at the work cell.

17. The method as claimed in claim 16, wherein the method comprises:
providing power supply to the machine such that there is no discontinuity in power supply to the machine before and after docking of the cart to the work cell.
